(19) United States
(12) Patent Application Publication
(10) Pub. No.: US 2020/0317375 A1
(43) Pub. Date: Oct. 8, 2020

(54) STEERING MECHANISM AND METHOD FOR MICRO-FUSION-POWERED AIR AND SPACE CRAFT

(71) Applicant: Jerome Drexler, Los Altos Hills, CA (US)

(72) Inventor: Jerome Drexler, Los Altos Hills, CA (US)

(21) Appl. No.: 16/374,462

(22) Filed: Apr. 3, 2019

(51) Int. Cl. B64G 1/40

(52) U.S. Cl. CPC B64G 1/408

(57) ABSTRACT

A micro-fusion powered spacecraft makes use of ambient cosmic rays and muons generated therefrom to provide micro-fusion propulsion. The craft has a centrally located internal reaction chamber with an upper dome and tapering to a bottom exhaust opening. The chamber is radially surrounded by the main body of the craft. Ports from a fuel supply in the main body inject a deuterium-containing micro-fusion fuel material as a dispersed cloud into the chamber. Ambient cosmic rays and muons penetrate the upper dome into the chamber and interact with the fuel to produce energetic reaction products. Some of the reaction products exit the chamber through the exhaust opening to provide reaction thrust, while other reaction products interact with the dome of the chamber to directly apply a thrusting force. The exhaust system has a set electrostatic plates that deflect reaction products to steer the reaction thrust. A coil electromagnet around the chamber steers and confines both the incoming charged muons and reaction products created within the chamber.

### TECHNICAL FIELD

The present invention relates to providing thrust to air and space craft with human occupants, and to inducement or production of controlled nuclear fusion by particle-target and muon-catalyzed micro-fusion for thrust in the presence of ambient cosmic rays and muons. The invention relates in particular to mechanisms for directing the thrust for steering the craft.

### BACKGROUND ART

Spacecraft today are propelled by chemical rockets that are inefficient and require a huge fuel load to reach orbit and then to traverse interplanetary space. Additionally, for future creation of bases on the Moon and eventually on Mars, there will be a need to efficiently move personnel and supplies from place to place. Surface transport may sometimes be difficult because of terrain. However, there is no atmosphere on the Moon to support aerial flight, so another means of providing thrust and lift must be used. Although Mars does have an atmosphere, it is extremely thin (an average of 600 Pascals or only 0.6% of Earth's atmospheric pressure), and while gravity is only about 38% of that on Earth, aerial-style flight will be extremely difficult (e.g. number and length of rotor blades and their speeds would collectively need to increase about 60-fold for comparable lift).

Several projects have explored the possibility of nuclear spacecraft propulsion. The first of these was Project Orion from 1958-1963 built upon general proposals in the 1940s by Stanislaw Ulam and others, in which external atomic detonations would form the basis for a nuclear pulse drive. Later, between 1973 and 1978, Project Daedalus of the British Interplanetary Society considered a design using inertial confinement fusion triggered by electron beams directed against fuel pellets in a reaction chamber. From 1987 to 1988, Project Longshot by NASA in collaboration with the US Naval Academy developed a fusion engine concept also using inertial confinement fuel pellets but this time ignited using a number of lasers. Naturally, these last two projects depend upon successfully achieving nuclear fusion.

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (about one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of Calif., Berkeley) correctly noted that for useful power production there would need to be an energetically cheap way of producing muons. The energy expense of generating muons artificially in particle accelerators combined with their short lifetimes has limited its viability as an Earth-based fusion source, since it falls short of break-even potential.

Another controlled fusion technique is particle-target fusion which comes from accelerating a particle to sufficient energy to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in space. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 6 shows cosmic ray flux distribution at the Earth's surface after significant absorption by Earth's atmosphere. In near-Earth space, the alpha magnetic spectrometer (AMS-02) instrument aboard the International Space Station since 2011 has recorded an average of 45 million fast cosmic ray particles daily (approx. 500 per second within that instrument's effective acceptance area and measurement energy range). The overall flux of galactic cosmic ray protons (above Earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space), the cosmic ray flux has been estimated to be several orders of magnitude greater. As measured by the Martian Radiation Experiment (MARIE) aboard the Mars Odyssey spacecraft, average in-orbit cosmic ray doses were about 400-500 mSv per year, which is an order of magnitude higher than on Earth.

Cosmic rays are known to generate abundant muons from the decay of cosmic rays passing through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻²s⁻¹sr⁻¹ . The muon flux is even higher in the upper atmosphere. Measured muon flux levels on Earth reflect the fact that both Earth's atmosphere and geomagnetic field tend to deflect charged particles and shield our planet from cosmic radiation. The amount of shielding is somewhat lower, and thus the cosmic ray flux and muon generation are greater, at higher elevations and altitudes. Mars is a different story, having very little atmosphere (only 0.6% of Earth's pressure) and no magnetic field, so that muon generation at Mars' surface is expected to be very much higher than on Earth's surface.

In recent years, there have been proposals to send further spacecraft to Mars and then sending manned space vehicles to Mars. One such development project is by the private U.S. company SpaceX with aspirational plans for Mars flights with passengers by the mid-2020s. The United States has committed NASA to a long-term goal of human spaceflight and exploration beyond low-Earth orbit, including crewed missions toward eventually achieving the extension of human presence throughout the solar system and potential human habitation on another celestial body (e.g., the Moon, Mars).

This research and development activity is expected to proceed in several general stages, beginning with an Earth-reliant stage with research and testing on the ISS of concepts and systems that could enable deep space, long-duration crewed missions, followed by a proving ground stage in cis-lunar space to test and validate complex operations and components before moving on to largely Earth-independent stages. Such a proving ground stage would field one or more in-space propulsion systems capable of reaching Mars to undergo a series of shakedown tests to demonstrate their capabilities, select a final architecture, and make needed upgrades revealed by the shakedown tests. While systems already in development for the initial Earth-reliant missions largely make use of existing technologies, investment in the development of newer technologies will be needed to meet the longer-term deep space challenges.

One anticipated need is the ability to steer the craft toward desired trajectories. This may involve either supplemental thrust sources for providing lateral motion, changing of vehicle attitude, or ways of redirection of exhaust from reaction engines.

### SUMMARY DISCLOSURE

A micro-fusion powered spacecraft makes use of ambient cosmic rays and muons generated therefrom to provide micro-fusion propulsion. The craft has a centrally located internal reaction chamber with an upper dome and tapering to a bottom exhaust opening. The chamber is radially surrounded by the main body of the craft. Ports from a fuel supply in the main body inject a deuterium-containing micro-fusion fuel material as a dispersed cloud into the chamber. Ambient cosmic rays and muons penetrate the upper dome into the chamber and interact with the fuel to produce energetic reaction products. Some of the reaction products exit the chamber through the exhaust opening to provide reaction thrust, while other reaction products interact with the dome of the chamber to directly apply a thrusting force. The exhaust system has a set electrostatic plates that deflect reaction products to steer the reaction thrust. A coil electromagnet around the chamber steers and confines both the incoming charged muons and reaction products created within the chamber.

More particularly, a propulsion system for use by an air or space craft in the presence of an ambient flux of cosmic rays, comprises a central chamber located within a craft and surrounded by a main craft body. The central chamber has an upper dome and a bottom opening, as well as side walls of the chamber having one or more ports for injection of deuterium-containing particle fuel material. The fuel material interacts with the ambient flux of cosmic rays entering the chamber through the upper dome to generate reaction products having kinetic energy. A downwardly directed portion of the reaction products exits the chamber through the bottom opening to produce reaction thrust, while an upwardly directed portion of the reaction products is stopped by the upper dome to produce upward applied thrust upon the craft.

For steering, a deflection mechanism comprising a set of conductive deflection plates is located around the bottom opening. Pairs of opposed plates have an electrical voltage potential selectively applied across the bottom opening. This selectively deflects electrically charged reaction products escaping through the bottom opening to produce a specified direction of lateral motion. The deflection mechanism may comprise two orthogonal pairs of opposed deflection plates, each opposed pair of plates situated on opposite sides of the bottom opening. Applying voltages across one or both opposed pairs of plates steers the exiting alpha particles in a desired direction to produce the required thrust.

The reaction volume has a diameter selected such that thrust obtained exceeds gravitational force for a steady ground-based launch of the craft into orbit. For example, the craft might accelerate into successively higher orbits around a planet or moon of origination prior to insertion into an interplanetary trajectory, and likewise decelerate into successively lower orbits around a destination planet or moon prior to entry into a landing trajectory. The craft can be capable of round-trip travel between planets (or between a planet and moon).

Thrust-to-weight ratio from the reaction can be improved by use of a coil electromagnetic around the chamber. Applying an axial magnetic field by such an electromagnetic, the field steers muons and the charged reaction products away from side walls of the chamber and also focuses downwardly tending reaction products toward the bottom opening. More particularly, a propulsion system, for use by an air or space craft in the presence of an ambient flux of cosmic rays, again comprises a central chamber located within a craft and surrounded by a main craft body, the central chamber having an upper dome and a bottom opening. Here, the chamber is surrounded by a coil electromagnet that provides a substantially axial magnetic field within the chamber. The chamber can taper in dimension from a larger size at the dome to a smaller size at the bottom opening. As before, side walls of the chamber have one or more ports for injection of deuterium-containing particle fuel material, the fuel material interacting with the ambient flux of cosmic rays entering the chamber through the upper dome and with muons produced from the cosmic rays to generate charged reaction products having kinetic energy. An upwardly directed portion of the reaction products is stopped by the upper dome to apply upward thrust directly upon the craft. A downwardly directed portion of the reaction products exits through the bottom opening, the magnetic field focusing them toward the bottom opening.

### BRIEF DESCRIPTION OF THE DRAWINGS

FIG. 1 is a schematic side view showing an embodiment of an interplanetary craft for operation in the presence of ambient cosmic rays and muons and having micro-fusion generated thrust for lift and propulsion.

FIG. 2 is a side sectional view showing one embodiment of an internal reaction chamber for the craft in FIG. 1.

FIG. 3 is a side perspective view of a bottom opening of an internal reaction chamber as in FIG. 2 but having a deflection mechanism for escaping electrically-charged reaction products.

FIG. 4 is a bottom plan view of the deflection mechanism of FIG. 3.

FIG. 5 is a side sectional view showing another internal reaction chamber embodiment using a coil electromagnet.

FIG. 6 is a graph of cosmic ray flux at the Earth surface versus cosmic ray energy, after very significant cosmic ray absorption by Earth's atmosphere and dust has occurred.

### DETAILED DESCRIPTION

The present invention provides micro-fusion powered air or space craft, where the micro-fusion provides thrust for generating both lift from a planetary or lunar surface and lateral propulsion. The propulsion technology takes advantage of an abundance of ambient cosmic rays and muons generated from such cosmic rays to catalyze fusion events in enough amounts to produce useable thrust. The cosmic rays together with muons are available here for free and do not need to be generated artificially in an accelerator. The thrust also enables single-stage launch from (or landing upon) a lunar or planetary surface, including an ability to haul cargo and personnel up to some maximum weight that is dependent upon the amount of lift and propulsion provided by the micro-fusion. Since the amount of energy needed for thrust is generally much less than the multi-kiloton yields of atomic weapons, “micro-fusion” is the term used here to refer to fusion energy outputs of not more than 10 gigajoules per second (2.5 tons of TNT equivalent per second), to thereby exclude macro-fusion type explosions.

A craft is provided with a centrally located internal chamber with a dome on top and opening at the bottom. Deuterium-containing micro-fusion fuel material is inwardly injected at a specified rate into this chamber. Ambient cosmic rays and/or muons penetrate the dome from above and interact with the fuel material to generate energetic alpha particles and/or other reaction products that provide thrust to the craft. In particular, downwardly-directed alpha particles escape through the opening to produce a reaction thrust, while upwardly-directed alpha particles are stopped by the dome and produce applied thrust forces against the craft. Further, any fuel escaping through the bottom opening will also react externally with ambient cosmic rays and muons and the resulting reaction products will apply upward forces upon the underside of the craft. In interplanetary space, there is, of course, no “up” or “down” direction. But for convenience of discussion, the dome side of the craft will continue to be referred to as the “top” of the craft, even after liftoff from a planetary or lunar surface, while the side with the chamber opening will continue to be referred to as the “bottom” of the craft.

For lateral motion, the direction in which generally downward-directed alpha particles escape and produce reaction thrust can vary. In particular, the bottom opening may have a deflection mechanism (e.g. based on electrostatic fields) that redirects or steers some or all the escaping alpha particles in a more lateral direction.

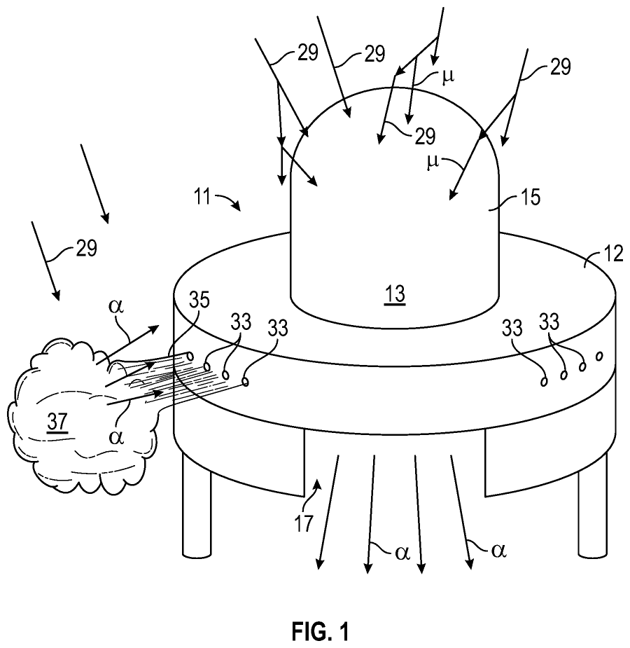

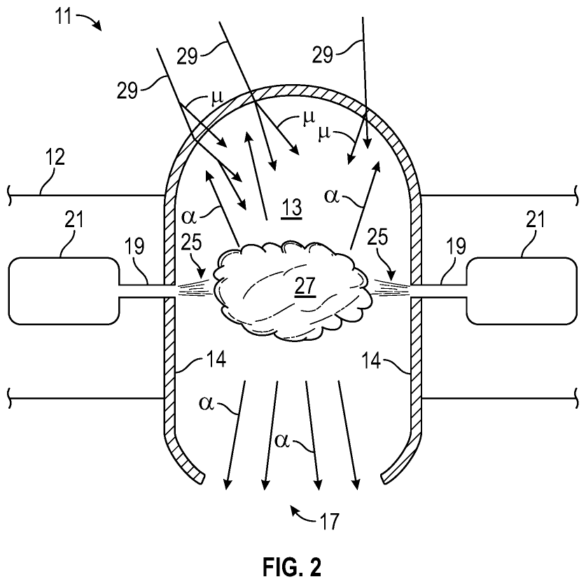

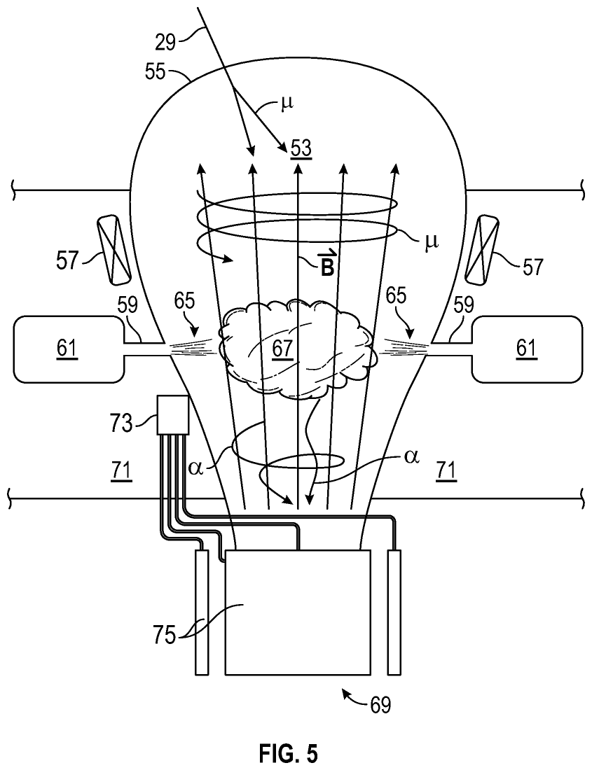

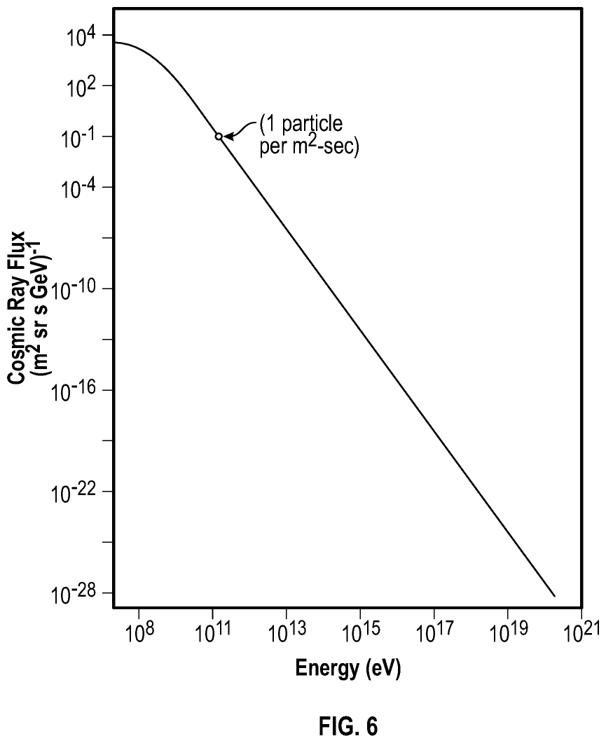

With reference to FIGS. 1 and 2, a craft 11 has a centrally located internal chamber 13 with a dome 15 on top and an opening 17 at the bottom. The craft 11 therefore constitutes a roughly disk-shaped, toroidal, tubular or doughnut-shaped main body portion 12 surrounding an internal chamber 13 which can extend somewhat above the top of the craft body by means of a bubble region with a dome 15 serving as a cover for the chamber 13. However, neither the central chamber 13 nor the main body portion 12 surrounding the central chamber 13 need be circular or radially symmetric, but could have an oval, elliptical, polygonal, or other odd shape. Cylindrical chambers and disc-shaped main bodies may be preferred for their compactness and economy of material, but other shapes are possible. More specifically, it will be seen later in FIG. 5, that where a coil electromagnet is used to steer the charged reaction products toward the exhaust opening, the chamber may taper in dimension from a larger dome end to a smaller exhaust end, freeing up additional space around the chamber for cargo or crew space.

The dome 15 is effectively transparent to cosmic rays, with their extremely high energies (>100 Mev) and penetrating power, but essentially opaque to the substantially lower energy (˜10 MeV) alpha particle reaction products that will thus be stopped by the dome. It is expected that the dome material can be the same as the external skin 12 of the craft 11, but thinner. However, research and development efforts may optimize the choice of dome material and its thickness to achieve maximum cosmic ray penetration into the chamber 13, as well as to facilitate production of muons through interactions of those cosmic rays with the dome material. The dome 15 might even be double-paned structure with internal wire mesh, fibers and or even fine particulates to enhance muon creation. (Such a double-paned structure may also facilitate the provision of a cooling water or gas flow between the panes.) Such the presence of muon generators as a permanent structure of the dome 15 will lessen or even eliminate the need for having muon-generating particulate material within the fuel, thereby saving valuable fuel weight.

Additionally, the amount of curvature of the dome may be important to maximizing input of cosmic rays and muons into the chamber 13. The curvature of the “dome” may range from being completely flat to extending considerably upward above the top of the remainder of the craft 11, perhaps as much as twice as high as its radius. The much larger surface area of a large curvature dome 15 would facilitate cooling of the cover as it is bombarded with ambient cosmic rays penetrating from outside and with micro-fusion reaction products (energetic alpha particles α) from within. A larger curvature might also allow relief of mechanical stresses from any heating that does result. It will also be shown that where, as in FIG. 5, a coil electromagnet is used around the chamber, the resulting axial magnetic field can serve to steer incoming charged muons (and to a lesser extent the more energetic cosmic rays) away from the chamber's side walls, making more of them available over a longer distance for interaction with the injected micro-fusion fuel material in the chamber 13.

Except for fuel injection ports 19 leading into the chamber 13, the internal chamber is otherwise isolated from the rest of the craft 11 that radially surrounds it. Specifically, the sides 14 of the chamber 13, seen in FIG. 2, preferably provide sufficient radiation shielding to protect the craft's occupants and supplies, as well as stored fuel not yet injected into the chamber 13.

One or more fuel injection ports 19 are positioned in the sides 14 of the chamber 13 for ejecting micro-fusion fuel particles 25 from a stored supply 21 to create a cloud 27 of such material within the chamber 13. Ambient cosmic rays 29 and muons μ generated from those cosmic rays penetrate the dome 15 and react with the cloud 27 of micro-fusion material to generate energetic fusion products, such as alpha particles α. At least some of these energetic fusion products are received by the craft 11 to provide upward thrust or lift. Specifically, some of the alpha particles α will be directed downward and escape through the opening 17 at the bottom of the chamber. These will provide an upward reaction thrust. Other alpha particles α will be directed upward and be stopped by the dome 15. These will produce an upward applied thrust force against the craft 11. Alpha particles α directed laterally in all directions will provide counteracting effects and negligible thrust contributions. However, where an electromagnet is employed, some laterally directed of the charged alpha particles will be sufficiently steered by the magnetic field away from the side walls and may thus be more likely, if it has some upward or downward component of motion, to eventually interact with the dome or exit through the bottom exhaust opening. Some of the deuterium-containing micro-fusion fuel material will also escape through the opening 17 in the bottom of the chamber 13. However, immediately outside the craft 11, such fuel will also interact with ambient cosmic rays and muons to generate micro-fusion reaction products (alpha particles α) at least some of which will be directed upward onto the underside of the craft 11. These will likewise apply an upward thrust force upon the craft 11. The combination of contributing upward forces will produce lift.

In a similar manner, the craft 11 could further include a supplemental supply of deuterium-containing micro-fusion fuel particles that can be propelled externally below an underside of the craft (e.g. from ports located on the underside of the craft) so as to interact with ambient cosmic rays and muons external to the craft to produce reaction products having kinetic energy. The additional upwardly directed portion of these reaction products will thus apply additional upward thrust upon the underside of the craft 11.

FIG. 1 also shows the possibility of having external ejection of deuterium-containing micro-fusion fuel material 35 through external side (or bottom) ports 33 to create an external cloud 37 of such material that can interact with incoming cosmic rays and/or muons 29 to produce alpha particles α, at least some of which will apply a direct force upon the outside of the craft 11.

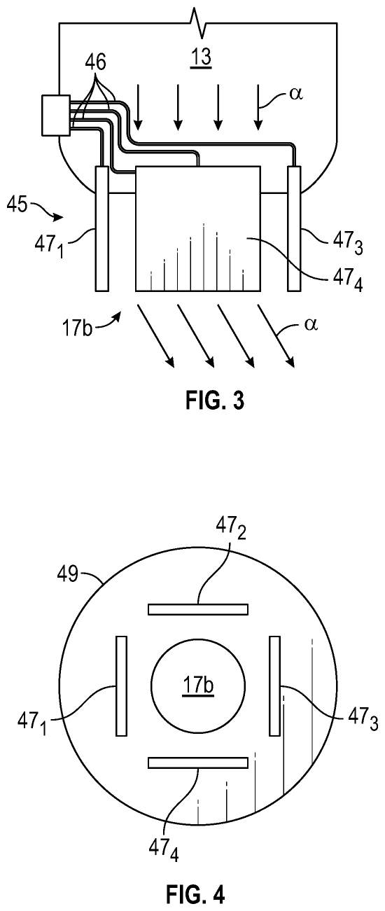

With reference to FIG. 3, as a way of producing lateral thrust, because alpha particles have an electric charge, a deflection mechanism 45 at the bottom opening 17b of the chamber 13 can deflect or steer the alpha particles α and give them a lateral component of motion. For example, as shown in FIG. 4, one mechanism for deflecting alpha particle exhaust can create an electric field using a set of conductive plates 47₁, 47₂, 47₃ and 47₄. Opposed plates 47₁ and 47₃ are orthogonal to opposed plates 47₂ and 47₄. One or both opposed pairs of plates 47₁ and 47₃ (or 47₂ and 47₄) can have a selectively applied voltage potential across the bottom opening. The voltage differential creates a lateral electric field that deflects the positively charged alpha particles traversing the space between those plates. The size and direction of that field can be varied by changing the voltages applied to the various opposed plates, thereby varying the field. The amount of electricity required for deflection should be relatively small. Using this method, a pilot can vary the speed and direction of the craft 11 by varying the amount and direction of lateral thrust provided by the alpha particles.

The fuel can be solid Li⁶D in powder form, D-D or D-T inertial-confinement-fusion-type pellets, or D₂O ice crystals, or even droplets of (initially liquid) D₂. Various types of micro-fusion reactions may also occur, such as Li⁶-D reactions, generally from direct cosmic ray collisions, as well as D-T, using tritium generated by cosmic rays impacting the lithium-6. D-T reactions especially may be assisted by muon-catalyzed fusion.

Muon-created muonic deuterium can come much closer to the nucleus of a similar neighboring atom with a probability of fusing deuterium nuclei, releasing energy. Once a muonic molecule is formed, fusion proceeds extremely rapidly (˜10⁻¹⁰ sec). One cosmic ray particle moving through the atmosphere and dust can generate hundreds of muons, and each muon can typically catalyze about 100 micro-fusion reactions before it decays (the exact number depending on the muon “sticking” cross-section to any helium fusion products).

Besides D-D micro-fusion reactions, other types of micro-fusion reactions may also occur (e.g. D-T, using tritium generated by cosmic rays impacting the lithium-6; as well as Li⁶-D reactions from direct cosmic ray collisions). In the reaction, Li⁶+D→2He⁴+22.4 MeV, much of the useful excess energy is carried as kinetic energy of the two helium nuclei (alpha particles). For this latter reaction, it should be noted that naturally occurring lithium can have an isotopic composition ranging anywhere from as little as 1.899% to about 7.794% Li⁶, with most samples falling around 7.4% to 7.6% Li⁶. Although LiD that has been made from natural lithium sources can be used in lower thrust applications or to inhibit a runaway macro-fusion event, fuel material that has been enriched with greater proportions of Li⁶ is preferable for achieving greater thrust and efficiency.

Additionally, the cosmic rays can themselves directly stimulate micro-fusion events by particle-target fusion, wherein the high energy cosmic ray particles (mostly protons, but also helium nuclei) bombard relatively stationary target material. When bombarded directly with cosmic rays, the lithium-6 may be transmuted into tritium which could form the basis for some D-T micro-fusion reactions. Although D-D micro-fusion reactions occur at a rate only 1% of D-T micro-fusion, and produce only 20% of the energy by comparison, the freely available flux of cosmic rays and their generated muons should be sufficient to yield sufficient micro-fusion energy output for practical use.

The dispersed cloud of micro-fusion target material will be exposed to ambient cosmic rays and muons. To assist muon formation, the micro-fusion fuel material may contain up to 20% by weight of added particles of fine sand or dust. As cosmic rays collide with the micro-fusion material and dust, they form muons μ that are captured by the deuterium and that catalyze fusion. Muon formation may also be facilitated by reaction of cosmic rays with the dome material. Likewise, the cosmic ray collisions themselves can directly trigger particle-target micro-fusion.

The micro-fusion fuel material may be sprayed continuously as needed to sustain the fuel clouds both within the chamber 13 and externally adjacent to the craft 11. The amount of energy generated by the micro-fusion reactions, and the thrust the micro-fusion products produce, depends upon the quantity of fuel injected into the chamber 13 and the quantity of available cosmic rays and muons in the ambient environment that can enter the craft through the dome 15. Assuming much of the energy can be captured and made available for thrust, an estimated 10¹⁵ individual micro-fusion reactions (less than 1 μg of fuel consumed) per second would be required for 1 kW output. But as each cosmic ray can create hundreds of muons and each muon can catalyze about 100 reactions, the available cosmic ray flux in interplanetary space (believed to be several orders of magnitude greater than on Earth) is believed to be sufficient for this thrust purpose following research, development, and engineering efforts.

It is noted that as a craft is enlarged in its design, the potential energy output tends to scale as the square of the central reaction chamber's diameter, while the bulk of the craft's mass, located mainly in the disk main body surrounding the chamber, tends to scale only linearly according to the craft's circumference. As such, the craft may be scaled up to large enough dimensions to even become capable of single-stage launch from a planetary surface. Thrust need only exceed the force of gravity for that purpose.

The volume of the continuous slow fusion creates high velocity fusion products (fast alpha particles or helium “wind”, etc.) that bombard the exterior of the craft. The energetic alpha particle micro-fusion products (α) provide thrust against the craft.

Stored fuel material 21 will be shielded within the craft 11 to reduce or eliminate premature micro-fusion events until delivered and dispersed as a fuel cloud within the interior chamber or outside the craft for thrusting. An inter-planetary astronaut crew will itself need shielding from radiation (which can cause brain damage and other adverse health effects). Therefore, the crew's shielding in the main body or disk section of the craft could double as a shield for the fuel material. One important source of such shielding will be the spacecraft's water supply, which should be adequate for the task. One need not completely eliminate cosmic rays or their secondary particles (pions, muons, etc.) to zero, but merely reduce their numbers and energies sufficiently to keep them from catalyzing sufficiently large numbers of fusion events in the stored target particle material. Additionally, since the use of micro-fusion fuel is expected to reduce the required amount of chemical rocket propellant by a factor of about two, one can easily afford the extra weight of some small amount of metal for shielding, if needed. (For example, the Juno spacecraft to Jupiter contains radiation vaults of 1 cm thick titanium to shield its electronics from external radiation. A similar type of vault might be used in this case for the shielding of the stored fuel.) After being shot from the spacecraft, the casing of the projectiles themselves will continue to provide some shielding until dispersal of the target particle material as a cloud.

Because the technology is still early in a developmental phase, testing of its concepts might be perfected at some locations on Earth before its deployment in outer space, even though the ambient flux of cosmic rays and muons may be much lower due to Earth's geomagnetic field and thick atmosphere. Testing with craft at convenient higher altitude Earth locations would allow designers to improve the proposed micro-fusion engines before their use in traveling to and from the Moon, and then Mars. (Both cosmic ray flux and muon generation are known to substantially increase with altitude.) When used on Earth, some care will be needed when using some micro-fusion fuels. For example, lithium hydride (including Li⁶D) is known to be violently chemically reactive in the presence of water. While reactions with water are not a problem on the Moon or Mars, with any Earth applications the fuel material will need to be encapsulated to isolate it from water sources, including atmospheric vapor. A desiccant can also be used when storing the fuel material.

With reference to FIG. 5, a reaction chamber 53 may have an “upper” dome 55 and “bottom” exhaust opening 69, as before. A coil electromagnet 57 surrounds the reaction chamber 53, at least around its upper section, creating a substantially axial magnetic field B. The chamber 53 can taper in size from a larger dome end to a smaller exhaust end. One or more stores 61 of deuterium-containing micro-fusion material 65 injects such fuel through ports 59 into the chamber 53 as a cloud 67. Incoming cosmic rays 29 and muons p generated from such cosmic rays enter the chamber through the dome 55. As is well known, charged particles interact with a magnetic field according to F=qv×B, where the force F is in a direction equal to the cross-product of the particle velocity and magnetic field vectors. Because of the magnetic field B, the charged muons μ may be steered by the field away from side walls of the chamber 53, following instead a downward spiral motion with a radius r dependent upon the muon momentum mv, charge q, and the magnetic field strength B, r=mv/qB. However, even a small magnetic field strength (where r is greater than the chamber diameter) will still cause the muons to traverse a longer path in the chamber before hitting a chamber wall. Vertical incoming muons will have the least interaction with the field (the cross-product is small in that case) but will need the steering effect the least. Incoming muons with a more lateral trajectory will need the steering effect the most but will also have a greater interaction with the magnetic field. Routine experimentation can determine an optimum field strength for the chamber.

The magnetic field has a similar effect upon the charged alpha particle reaction products α. More vertically directed reaction products will interact minimally with the field and hit the dome 55 or exit through the bottom opening 69 to produce thrust directly. The more laterally directed reaction products that are otherwise ineffective at producing thrust can be steered by the magnetic field in a spiral motion toward the exhaust opening 69 to produce reaction thrust. As in the previous chamber embodiment 13 of FIG. 2, this chamber may likewise have an electric field deflection mechanism with conductive plates 69 coupled to a voltage source 73, to direct the exiting the alpha particles for craft steering.

An advantage to having a tapered chamber 53 is that a greater diameter is available at the dome end 55 for receiving incoming cosmic rays and muons 29. Indeed, in some embodiments it might be possible that the dome end encompasses almost the full diameter of the craft. Then the diameter of the chamber shrinks toward the exhaust end to create usable space 71 for the crew and cargo. In some cases, the crew and cargo space might be entirely below the reaction volume, with only a small diameter port leading to a bottom opening. By tailoring the shape of the reaction volume, its effective size can be increased substantially to increase the thrust/weight ratio of the craft over more cylindrical shaped reaction chambers (perhaps as much as 3- or 4-fold, depending upon the design).

What is claimed is:

1. A propulsion system for use by an air or space craft in the presence of an ambient flux of cosmic rays, comprising:
a central chamber located within a craft and surrounded by a main craft body, the central chamber having an upper dome and a bottom opening, side walls of the chamber having one or more ports for injection of deuterium-containing particle fuel material, the material interacting with the ambient flux of cosmic rays entering the chamber through the upper dome to generate reaction products having kinetic energy, a downwardly directed portion of the reaction products exiting the chamber through the bottom opening to produce reaction thrust and an upwardly directed portion of the reaction products being stopped by the upper dome to produce upward applied thrust upon the craft; and
a deflection mechanism comprising a set of conductive deflection plates located around the bottom opening, with pairs of opposed plates selectively having an applied electric voltage potential for selectively deflecting electrically charged reaction products escaping through the bottom opening to produce a specified direction of lateral motion.

2. The propulsion system as in claim 1, wherein the deflection mechanism comprises two orthogonal pairs of opposed deflection plates, each opposed pair of plates situated on opposite sides of the bottom opening.

3. The propulsion system as in claim 1, wherein the deuterium-containing particle fuel material comprises Li⁶D.

4. The propulsion system as in claim 1, wherein the deuterium-containing particle fuel material comprises D₂O.

5. The propulsion system as in claim 1, wherein the deuterium-containing particle fuel material comprises D₂.

6. A method, operable in the presence of an ambient flux of cosmic rays, of producing lifting thrust upon a craft, comprising:
injecting deuterium-containing particle fuel material into an internal chamber of the craft, the chamber having an upper dome and a bottom opening, the material interacting with the ambient flux of cosmic rays and muons generated from the cosmic rays penetrating the upper dome to generate reaction products having kinetic energy inside the chamber, a downwardly directed portion of the reaction products exiting the chamber through the bottom opening to produce reaction thrust and an upwardly directed portion of the reaction products being stopped by the upper dome to produce upward applied thrust upon the craft; and
applying an applied electric voltage potential across a selected opposed set of conductive plates situated around the bottom the bottom opening to laterally deflect electrically charged reaction products escaping through the bottom opening in a direction to produce a specified component of lateral thrust.

7. The method as in claim 6, wherein the electric voltage potential is applied to one or both of two orthogonal pairs of opposed deflection plates, each opposed pair of plates situated on opposite sides of the bottom opening.

8. A propulsion system for use by an air or space craft in the presence of an ambient flux of cosmic rays, comprising:
a central chamber located within a craft and surrounded by a main craft body, the central chamber having an upper dome and a bottom opening, the chamber surrounded by a coil electromagnet that provides a substantially axial magnetic field within the chamber, the chamber tapering in dimension from a larger size at the dome to a smaller size at the bottom opening, side walls of the chamber having one or more ports for injection of deuterium-containing particle fuel material, the fuel material interacting with the ambient flux of cosmic rays entering the chamber through the upper dome and with muons produced from the cosmic rays to generate charged reaction products having kinetic energy, a downwardly directed portion of the reaction products exiting the chamber through the bottom opening to produce reaction thrust and an upwardly directed portion of the reaction products being stopped by the upper dome to produce upward applied thrust upon the craft, wherein the magnetic field steers muons and the charged reaction products away from the side walls of the chamber and focuses downwardly tending reaction products toward the bottom opening.

9. The propulsion system as in claim 8, further comprising a deflection mechanism in the form of a set of conductive deflection plates located around the bottom opening, with pairs of opposed plates selectively having an applied electric voltage potential for selectively deflecting electrically charged reaction products escaping through the bottom opening to produce a specified direction of lateral motion.

10. The propulsion system as in claim 9, wherein the deflection mechanism comprises two orthogonal pairs of opposed deflection plates, each opposed pair of plates situated on opposite sides of the bottom opening.

11. The propulsion system as in claim 8, wherein the deuterium-containing particle fuel material comprises Li⁶D.

12. The propulsion system as in claim 8, wherein the deuterium-containing particle fuel material comprises D₂O.

13. The propulsion system as in claim 8, wherein the deuterium-containing particle fuel material comprises D₂.

14. A method, operable in the presence of an ambient flux of cosmic rays, of producing lifting thrust upon a craft, comprising:
injecting deuterium-containing particle fuel material into an internal chamber of the craft, the chamber having an upper dome and a bottom opening, the material interacting with the ambient flux of cosmic rays and muons generated from the cosmic rays penetrating the upper dome to generate reaction products having kinetic energy inside the chamber, a downwardly directed portion of the reaction products exiting the chamber through the bottom opening to produce reaction thrust and an upwardly directed portion of the reaction products being stopped by the upper dome to produce upward applied thrust upon the craft; and
applying an axial magnetic field by a coil electromagnetic surrounding the chamber, the chamber tapering in dimension from a larger size at the dome to a smaller size at the bottom opening, the magnetic field steering muons and the charged reaction products away from side walls of the chamber and focusing downwardly tending reaction products toward the bottom opening.

15. The method as in claim 14, further comprising applying an electric voltage potential across selected opposed sets of conductive plates situated around the bottom the bottom opening to laterally deflect electrically charged reaction products escaping through the bottom opening in a direction to produce a specified component of lateral thrust.
